(19) United States
(12) Patent Application Publication
(10) Pub. No.: US 2024/0369449 A1
(43) Pub. Date: Nov. 7, 2024

(54) ABNORMAL SOUND DETERMINATION APPARATUS

(71) Applicants: Toshiba Infrastructure Systems & Solutions Corporation, Kawasaki-shi (JP); Toshiba Industrial Products and Systems Corporation, Kawasaki-shi (JP)

(72) Inventors: Tatsuya HIROSE, Kawasaki Kanagawa (JP); Fumiaki TAKEUCHI, Hachioji Tokyo (JP); Toshiaki Hirate, Kiyosu Aichi (JP); Junpei Kamiji, Mie Mie (JP)

(73) Assignees: Toshiba Infrastructure Systems & Solutions Corporation, Kawasaki-shi (JP); Toshiba Industrial Products and Systems Corporation, Kawasaki-shi (JP)

(21) Appl. No.: 18/772,580

(22) Filed: Jul. 15, 2024

Related U.S. Application Data
(63) Continuation of application No. PCT/JP2023/004819, filed on Feb. 13, 2023.

(30) Foreign Application Priority Data
Jun. 27, 2022 (JP) 2022-102665

(51) Int. Cl. G01M 13/045; G01H 17/00

(52) U.S. Cl. CPC G01M 13/045; G01H 17/00

(57) ABSTRACT

An apparatus of an embodiment includes a unit to calculate a parameter of a frequency component in a sound, calculate an average of amplitudes and an average of frequencies based on an amplitude spectrum of the sound, if the parameter is smaller than a third threshold, and perform at least either of comparison between the average of the amplitudes and a first threshold and comparison between the average of the frequencies and a second threshold; and a unit to, if a result of the comparison satisfies a condition, acquire values and frequencies of peaks included in an amplitude spectrum based on a portion of the sound, calculate ranks of the values of the peaks times for different portions of the sound, and determine a cause of an abnormal sound based on a total score obtained by summing scores set in accordance with the ranks.

### CROSS-REFERENCE TO RELATED APPLICATIONS

This application is a Continuation application of PCT Application No. PCT/JP2023/004819, filed Feb. 13, 2023 and based upon and claiming the benefit of priority from Japanese Patent Application No. 2022-102665, filed Jun. 27, 2022, the entire contents of all of which are incorporated herein by reference.

### FIELD

Embodiments described herein relate generally to an abnormal sound determination apparatus.

### BACKGROUND

In rotary equipment, such as a motor, components deteriorate with the lapse of time. For example, it is known that a bearing which supports a rotor of a motor gradually deteriorates due to the rotation of the rotor, and as the deterioration progresses, an abnormal vibration or an abnormal sound is caused. Conventionally, an abnormal sound is detected by hearing, and thereafter an abnormal vibration is measured and analyzed with an acceleration sensor to diagnose an abnormal portion of the motor. At this time, if the abnormal sound is determined by human hearing, the standard for determination cannot be made consistent. If a rotation sound of the motor is measured by a microphone and a predetermined index is calculated, abnormality can be determined based on a consistent standard. Furthermore, if the vibration is measured by an acceleration sensor, the diagnosis can be accurate. In a case where a motor is diagnosed by measuring a vibration acceleration, it has been proposed that an overall value indicating the magnitude of an overall vibration is calculated, and the overall value is compared with a predetermined threshold to determine whether the motor has an abnormality. Furthermore, in a case where a cause of the abnormality is investigated based on the aforementioned determination, whether an amplitude at a bearing pass frequency (a frequency of passage of an inner ring or an outer ring calculated from the dimensions of the bearing and a rotation frequency at a damaged portion) is noticeable or not is checked on the amplitude spectrum of the vibration acceleration to determine a bearing damage.

In a case where an abnormality of a motor was determined by measuring a rotation sound generated from the motor, a sound other than the rotation sound, namely, a noise such as speaking voices of persons around the motor or work sounds, has been frequently mixed with the rotation sound, in which case it has been difficult to perform a primary determination from the loudness of the measured rotation sound of whether the motor had an abnormality. Therefore, if primary determination was not performed before a bearing pass frequency was analyzed, there have been cases in which a bearing was determined to be a cause of an abnormal sound even if the bearing was normal. Thus, it has been difficult to ensure the reliability of the abnormality determination. In addition, if a noise was unexpectedly mixed with the measured rotation sound, the frequency peak at which a noise corresponds to a pass frequency might further be increased. Such a case has also been a cause to lower the reliability of the abnormality determination.

### BRIEF DESCRIPTION OF THE DRAWINGS

FIG. 1 is a schematic diagram showing a configuration example of an abnormal sound determination apparatus according to an embodiment.

FIG. 2 is a flowchart for explaining an example of a primary determination processing operation of the abnormal sound determination apparatus according to the embodiment.

FIG. 3 is a flowchart for explaining an example of a pass frequency analysis operation of the abnormal sound determination apparatus according to the embodiment.

FIG. 4 is a flowchart for explaining an example of the pass frequency analysis operation of the abnormal sound determination apparatus according to the embodiment.

FIG. 5 is a flowchart for explaining an example of the pass frequency analysis operation of the abnormal sound determination apparatus according to the embodiment.

FIG. 6 is a schematic diagram showing an example of simulation results of the primary determination processing operation of the abnormal sound determination apparatus according to the embodiment.

FIG. 7 is a schematic diagram showing an example of simulation results of the primary determination processing operation of the abnormal sound determination apparatus according to the embodiment.

FIG. 8 is a schematic diagram showing an example of simulation results of the primary determination processing operation of the abnormal sound determination apparatus according to the embodiment.

FIG. 9 is a schematic diagram showing an example of simulation results of the pass frequency analysis operation of the abnormal sound determination apparatus according to the embodiment.

FIG. 10 is a schematic diagram showing an example of simulation results of the pass frequency analysis operation of the abnormal sound determination apparatus according to the embodiment.

### DETAILED DESCRIPTION

According to an embodiment, an abnormal sound determination apparatus comprises a primary determination processing unit configured to calculate a symptom parameter of a frequency component in a predetermined range of a sound signal, and if the symptom parameter is smaller than a third threshold, calculate an average value of amplitudes and an average value of frequencies based on a plurality of peaks in an amplitude spectrum of the sound signal, and perform at least either of comparison between the average value of the amplitudes and a first threshold and comparison between the average value of the frequencies and a second threshold; and a pass frequency analysis unit configured to, if a result of the comparison in the primary determination processing unit satisfies a predetermined condition, acquire values and frequencies of a plurality of peaks included in an amplitude spectrum based on a portion of the sound signal, calculate ranks of the values of the plurality of peaks a plurality of times for different portions of the sound signal, and determine a cause of an abnormal sound based on a total score obtained by summing scores set in accordance with the ranks for each of the frequencies of the plurality of peaks.

An abnormal sound determination apparatus according to an embodiment will now be described in detail with reference to the accompanying drawings. In the drawings used for describing the embodiment, the scale of each portion is changed as appropriate. Furthermore, in the drawings used for describing the embodiment, components are appropriately omitted for the purpose of explanation.

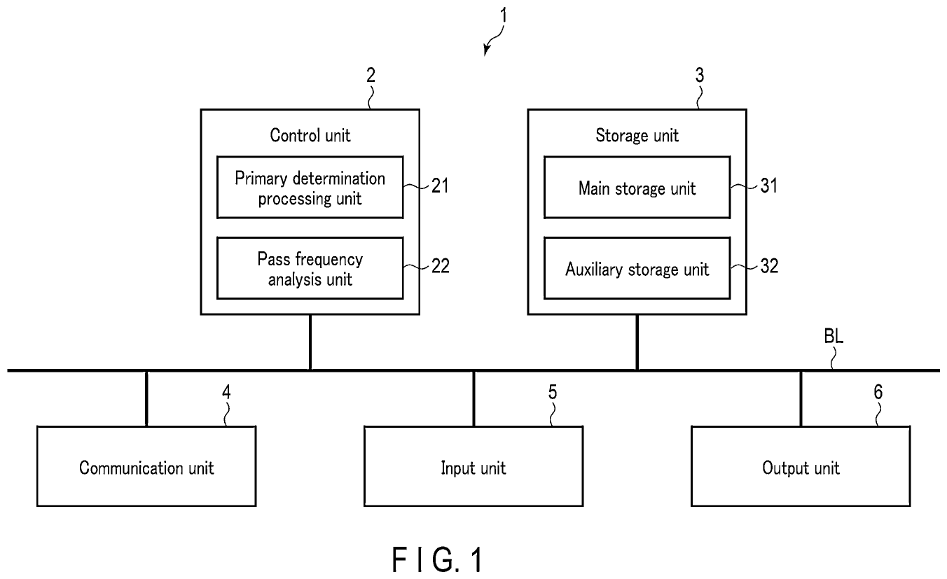

FIG. 1 is a schematic diagram showing a configuration of an example of an abnormal sound determination apparatus 1 according to an embodiment.

The abnormal sound determination apparatus 1 of the embodiment includes a control unit 2, a storage unit 3, a communication unit 4, an input unit 5, an output unit 6, and a bus communication line BL.

The bus communication line BL is connected to each of the components included in the abnormal sound determination apparatus 1.

The control unit 2 is capable of transmitting and receiving data to and from the other components included in the abnormal sound determination apparatus 1 via the bus communication line BL.

The communication unit 4 receives data from the components in the abnormal sound determination apparatus 1, outputs data to external equipment, and transmits data received from external equipment to the components in the abnormal sound determination apparatus 1. The communication unit 4 is capable of communicating based on communication standards of, for example, the Internet, Ethernet (registered trademark), a wireless LAN (such as Wi-Fi (registered trademark)), Bluetooth (registered trademark), etc.

The input unit 5 may include a user interface, such as a mouse, a keyboard, and the like, a microphone, a touch panel, a camera, and a variety of sensors. The input unit 5 transmits information acquired by an operation of a user to the control unit 2 through the bus communication line BL. With regard to a method for acquiring a rotation sound signal of a motor in the abnormal sound determination apparatus 1 of the embodiment, the rotation sound signal may be collected by a microphone or the like mounted on the abnormal sound determination apparatus 1. Alternatively, the rotation sound signal may be collected by a sound collector or the like disposed outside the apparatus, and received from outside via the communication unit 4.

The output unit 6 may include display means such as a monitor, and voice output means such as a loudspeaker. The output unit 6 may be configured to be connected to the outside of a computer.

The control unit 2 includes at least one processor, such as a central processing unit (CPU), a micro processing unit (MPU), a graphics processing unit (GPU), a field-programmable gate array (FPGA), or the like. The control unit 2 can realize a variety of functions of the abnormal sound determination apparatus 1 based on programs stored in an auxiliary storage unit 32, such as system software, application software, firmware, or the like.

The control unit 2 includes a primary determination processing unit 21 and a pass frequency analysis unit 22.

The primary determination processing unit 21 executes primary determination processing for a sound signal acquired from the storage unit 3 to primarily determine whether the motor has an abnormality. The primary determination processing unit 21 calculates a symptom parameter in frequency components in a predetermined range of the sound signal, and compares the symptom parameter with a third threshold. If the symptom parameter is smaller than the third threshold, the primary determination processing unit 21 acquires an average value (sound pressure level [dB]) of amplitudes and an average value of the frequencies in an amplitude spectrum, and performs at least either of a comparison between the average value of the amplitudes and a first threshold and a comparison between the average value of the frequencies and a second threshold. Details of operations of the primary determination processing unit 21 will be described later.

The pass frequency analysis unit 22 performs processing to identify a cause of the abnormality in accordance with a result of the comparison by the primary determination processing unit 21. The pass frequency analysis unit 22 acquires a plurality of peaks in the amplitude spectrum of the sound signal acquired from the storage unit 3, and outputs a total score calculated based on ranks of the peaks. Details of operation of the pass frequency analysis unit 22 will be described later.

The storage unit 3 includes a main storage unit 31 and an auxiliary storage unit 32.

The main storage unit 31 may include, for example, a read-only memory (ROM) and a random-access memory (RAM). The ROM is a non-volatile memory to be used exclusively for reading data, and can store data and a variety of setting values that the control unit 2 uses for various processing. The RAM can be utilized as a so-called work area for temporarily storing data when the control unit 2 performs various processing. The main storage unit 31 of the present embodiment is, for example, a RAM and is used as a memory.

The main storage unit 31 can temporarily store a first peak rank corresponding to an inner ring frequency peak rank, a second peak rank corresponding to an outer ring frequency peak rank, a third peak corresponding to a rolling element frequency peak rank, a fourth peak rank corresponding to a retainer frequency peak rank, a first total score calculated from the first peak rank, a second total score calculated from the second peak rank, a third total score calculated from the third peak rank, a fourth total score calculated from the fourth peak rank, and a fifth total score (total value) obtained by adding the first to fourth total scores.

The auxiliary storage unit 32 is a non-transitory computer-readable storage medium of a computer containing the control unit 2 as a central unit. The auxiliary storage unit 32 is, for example, an electrically erasable programmable read-only memory (EEPROM) (registered trademark), a hard disk drive (HDD), a solid state drive (SSD), or the like.

The auxiliary storage unit 32 can store data to be used by the control unit 2 when performing various processing, data generated by the processing performed by the control unit 2, or a variety of setting values, and the like. For example, the auxiliary storage unit 32 is a memory for storing various information, and can store a sound signal, a frequency component in a predetermined range extracted from the sound signal, a symptom parameter of the extracted component, an amplitude spectrum of the sound signal, a peak of the amplitude spectrum, an average value of amplitudes, an average value of frequencies, an envelope signal, a first peak rank corresponding to an inner ring frequency peak rank, a second peak rank corresponding to an outer ring frequency peak, a third peak rank corresponding to a rolling element frequency peak, a fourth peak rank corresponding to a retainer frequency peak, a first total score calculated from the first peak rank, a second total score calculated from the second peak rank, a third total score calculated from the third peak rank, a fourth total score calculated from the fourth peak, a fifth total score obtained by adding the first to fourth total score, a first threshold, a second threshold, a third threshold, and a fourth threshold.

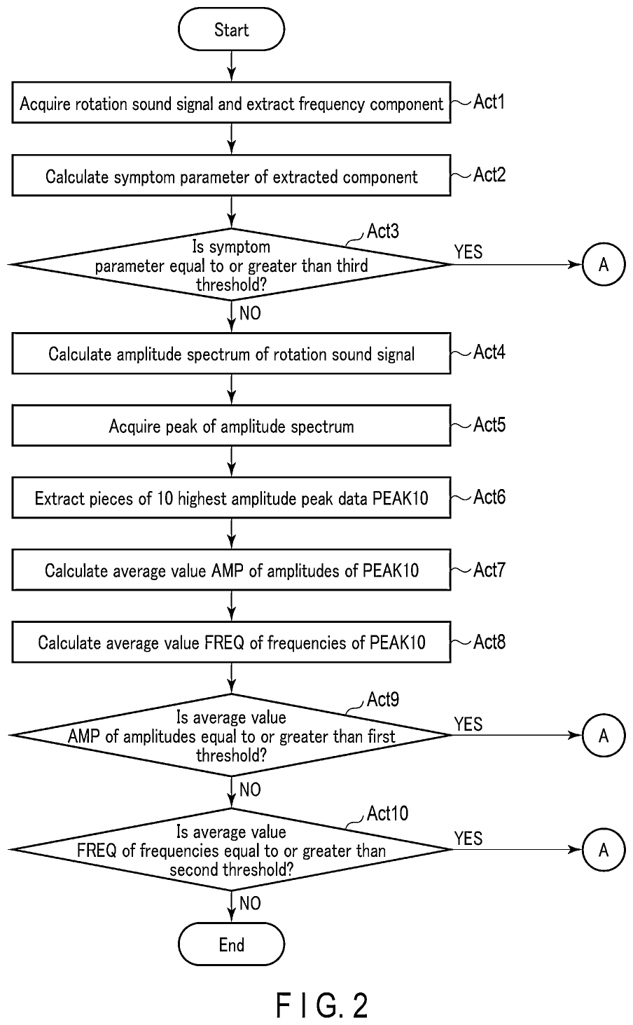

FIG. 2 is a flowchart for explaining an example of a primary determination processing operation of the abnormal sound determination apparatus according to the embodiment.

An example of a procedure of analyzing a sound signal of the motor and determining a cause of the abnormal sound by the abnormal sound determination apparatus 1 will be described below. Contents of the processing in the operation described below are mere examples, and various processing that can produce a similar effect can also be utilized.

The abnormal sound determination apparatus 1 acquires a sound signal of the motor via the input unit 5, such as a microphone. Alternatively, the abnormal sound determination apparatus 1 may receive, via the communication unit 4, a sound signal of the motor collected by another sound collector, and outputs the received sound signal to the storage unit 3.

The control unit 2, in particular, the primary determination processing unit 21, acquires the sound signal stored in the storage unit, and extracts a sound signal component of a predetermined frequency range. In the present embodiment, for example, the primary determination processing unit 21 extracts a sound signal component of a predetermined frequency range by passing the sound signal through a high-pass filter of a cutoff frequency of 1 kHz (step Act1).

The primary determination processing unit 21 calculates a symptom parameter of the extracted component of the predetermined frequency range. The primary determination processing unit 21 calculates an overall value of 1 kHz or higher as the symptom parameter (step Act2).

The primary determination processing unit 21 compares the calculated symptom parameter with the third threshold (step Act3). The third threshold may be set in advance by a user of the abnormal sound determination apparatus 1 or the like, or may be changed by the primary determination processing unit 21 each time processing is performed.

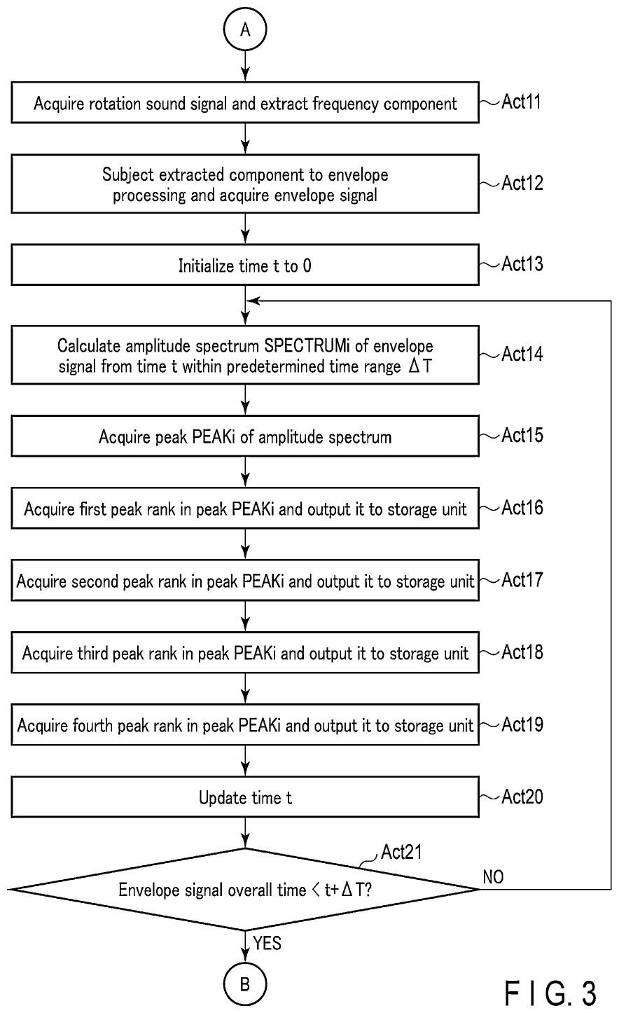

If the primary determination processing unit 21 determines that the symptom parameter is equal to or greater than the third threshold as a result of the comparison in step Act3 (step Act3, YES), the primary determination processing is shifted to processing of the pass frequency analysis unit 22 (shown in FIG. 3).

If the primary determination processing unit 21 determines that the symptom parameter is smaller than the third threshold (step Act3, NO), an amplitude spectrum of the sound signal is calculated. The amplitude spectrum is a sequence of amplitude data, and an index of the sequence represents a frequency (step Act4).

Next, the primary determination processing unit 21 acquires peaks of the calculated amplitude spectrum (step Act5).

Then, the primary determination processing unit 21 extracts pieces of ten highest amplitude peak data PEAK10 of the acquired peaks in descending order (step Act6).

In the example shown in FIG. 2, the primary determination processing unit 21 extracts the pieces of the ten highest amplitude data PEAK10. However, the number of pieces of extracted amplitude data is not limited to ten, and at least one piece of highest amplitude peak data may be extracted.

After extracting the amplitude peak data PEAK10, the primary determination processing unit 21 calculates an average value AMP of the amplitudes of the amplitude peak data PEAK10 (step Act7).

Furthermore, the primary determination processing unit 21 calculates an average value FREQ of the frequencies of the amplitude data PEAK10 (step Act8).

After calculating the amplitude average value AMP and the frequency average value FREQ, the primary determination processing unit 21 compares the amplitude average value AMP with the first threshold (step Act9).

If the amplitude average value AMP is equal to or greater than the first threshold (step Act9, YES), the processing is shifted from the primary determination processing to the processing of the pass frequency analysis unit 22 (shown in FIG. 3).

If the amplitude average value AMP is smaller than the first threshold as a result of the comparison of step Act9 (step Act9, NO), the primary determination processing unit 21 compares the frequency average value FREQ with the second threshold (step Act10).

If the frequency average value FREQ is equal to or greater than the second threshold (step Act10, YES), the processing is shifted from the primary determination processing to the processing of the pass frequency analysis unit 22 (shown in FIG. 3).

If the value FREQ is smaller than the second threshold in the result of the comparison of step Act10 (step Act10, NO), the primary determination processing unit 21 ends the primary determination processing.

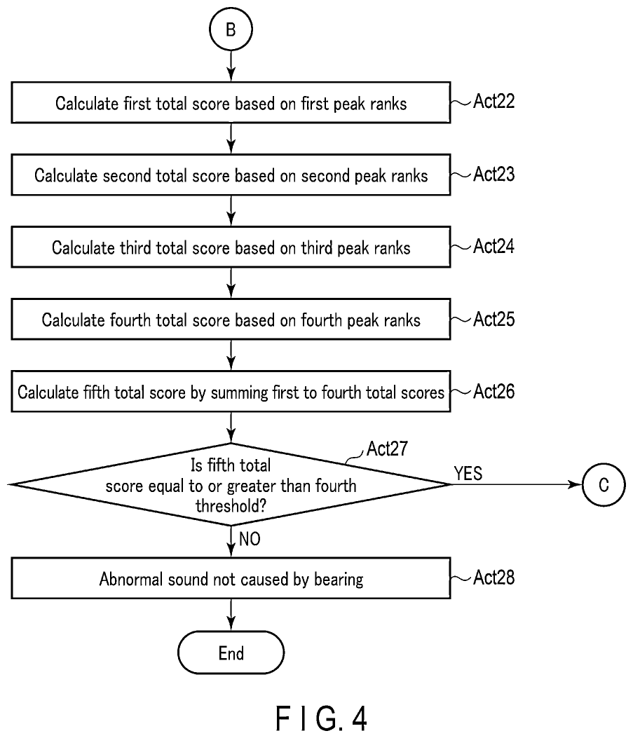

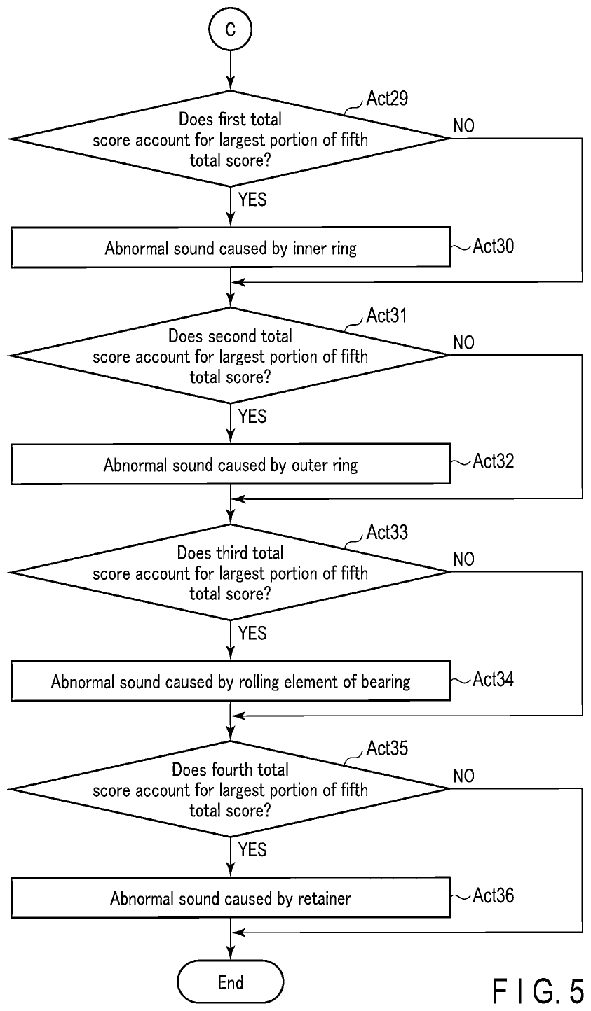

FIG. 3 to FIG. 5 are flowcharts for explaining an example of a pass frequency analysis operation of the abnormal sound determination apparatus according to the embodiment.

In step Act3, step Act9, or step Act10 described above, if the comparison target is equal to or greater than the predetermined threshold (if the predetermined condition is satisfied), the pass frequency analysis unit 22 performs a pass frequency analysis.

The pass frequency analysis unit 22 acquires the sound signal stored in the storage unit 3, and extracts a sound signal component of the predetermined frequency range. In the present embodiment, the pass frequency analysis unit 22 extracts the sound signal component of the predetermined frequency range by passing the sound signal through a band pass filter having a cutoff frequency of 1 kHz to 10 kHz (step Act11).

The pass frequency analysis unit 22 performs envelope processing by subjecting the extracted sound signal component to absolute value processing and thereafter low-pass filtering, to obtain an envelope signal (step Act12).

Subsequently, the pass frequency analysis unit 22 sets a time t as an envelope signal start time (=0) (Act13).

Next, the pass frequency analysis unit 22 calculates an amplitude spectrum SPECTRUMi of a portion of the envelope signal, that is, from the time t within a predetermined time range Δt (time width) (step Act14).

The pass frequency analysis unit 22 acquires a peak PEAKi of the calculated amplitude spectrum SPECTRUMi (step Act15).

The pass frequency analysis unit 22 acquires a rank within the peak PEAKi (hereinafter referred to as a first peak rank PO1) for a magnitude of the peak value of the amplitude spectrum SPECTRUMi in the inner ring pass frequency of a bearing mounted on the motor (step Act15).

The rank acquired in this step may be a rank that is assigned in descending order or a rank that is assigned in ascending order.

Similarly, the pass frequency analysis unit 22 acquires a rank within the peak PEAKi (hereinafter referred to as a second peak rank PO2) for a magnitude of the peak value of the amplitude spectrum SPECTRUMi in the outer ring pass frequency of the bearing mounted on the motor (step Act16).

The pass frequency analysis unit 22 acquires a rank within the peak PEAKi (hereinafter referred to as a third peak rank PO3) for a magnitude of the peak value of the amplitude spectrum SPECTRUMi in the rolling element pass frequency of the bearing mounted on the motor (step Act17).

The pass frequency analysis unit 22 acquires a rank within the peak PEAKi (hereinafter referred to as a fourth peak rank PO4) for a magnitude of the peak the amplitude spectrum SPECTRUMi in the retainer pass frequency of the bearing mounted on the motor (step Act18).

The pass frequency analysis unit 22 records the acquired first peak rank PO1 to fourth peak rank PO4 in the storage unit 3 (step Act19).

The pass frequency analysis unit 22 updates the time t by adding a unit time to the time t (step Act20).

Subsequently, the pass frequency analysis unit 22 compares a time when a predetermined time range ΔT has passed since the time t (the time t+the predetermined time range ΔT) with a time when the envelope signal ends (step Act21).

The index i represents the number of times the processing in step Act14 to step Act21 is executed. For example, if the pass frequency analysis unit 22 proceeds to step Act14 after step Act13, the processing is started using 1 as the index i. Thereafter, each time the processing of step Act21 is returned to step Act14, 1 is added to the numerical value of the index i. Therefore, in step Act14 to step Act21, the numeral of the index i is common to the amplitude spectrum SPECTRUMi and the peak PEAKi.

The pass frequency analysis unit 22 links, for example, the index i with the amplitude spectrum SPECTRUMi, the peak PEAKi, the first peak rank PO1, the second peak rank PO2, the third peak rank PO3, and the fourth peak rank PO4, and records them in the storage unit 3. For example, when the index i is 1, if the first peak rank PO1 is the first rank, the pass frequency analysis unit 22 links i with 1 and records PO1=1 in the storage unit 3, and if the second peak rank PO2 is the second rank, the pass frequency analysis unit 22 links i with 1 and records PO2=2 in the storage unit 3.

The unit time and the predetermined time range ΔT added to the time t in step Act20 can be set in accordance with a maximum value of the index i, a sampling frequency of the sound signal, an overlap ratio (a ratio of overlapping between a period of an envelope signal for use in calculating the amplitude spectrum SPECTRUMi and a period of an envelope signal for use in calculating the amplitude spectrum SPECTRUM (i+1)), etc. For example, if the overlap ratio is 50%, the pass frequency analysis unit 22 updates the time t to a time (t+ΔT)/2 in step Act20.

Until the time t plus the predetermined time range ΔT exceeds the end time of the envelope signal, the pass frequency analysis unit 22 repeats the processing from step Act14 to step Act21.

When the time t plus the predetermined time range ΔT exceeds the end time of the envelope signal, the pass frequency analysis unit 22 acquires a plurality of first peak ranks PO1 recorded in the storage unit 3 in step Act16, sums all scores corresponding to the first peak ranks, and calculates a first total score (step Act22).

In the pass frequency analysis unit 22, a score corresponding to each rank is assigned in advance. For example, the pass frequency analysis unit 22 sets 16 to the first rank, 8 to the second rank, 4 to the third rank, 2 to the fourth rank, and 1 to the fifth rank. The setting of the scores in the pass frequency analysis unit 22 can be set by the user of the abnormal sound determination apparatus 1 or the like in advance.

Similarly, the pass frequency analysis unit 22 acquires a plurality of second peak ranks PO2 recorded in the storage unit 3, sums all scores corresponding to the second peak ranks PO2, and calculates a second total score (step Act23).

The pass frequency analysis unit 22 acquires a plurality of third peak ranks PO3 recorded in the storage unit 3, sums all scores corresponding to the third peak ranks PO3, and calculates a third total score (step Act24).

The pass frequency analysis unit 22 acquires a plurality of fourth peak ranks PO4 recorded in the storage unit 3, sums all scores corresponding to the fourth peak ranks PO4, and calculates a fourth total score (step Act25).

The pass frequency analysis unit 22 sums the first total score, the second total score, the third total score, and the fourth total score calculated in step Act22 to step Act25, and calculates the fifth total score (total value) (step Act26).

The pass frequency analysis unit 22 compares the fifth total score with the fourth threshold (step Act27).

If the pass frequency analysis unit 22 determines that the fifth total score is smaller than the fourth threshold, the pass frequency analysis unit outputs information indicating that the abnormal sound (noise or the like) in the sound signal acquired from the motor has not been caused by the bearing, and ends the processing.

If the fifth total score is equal to or greater than the fourth threshold, the pass frequency analysis unit 22 determines which of the first total score to the fourth total score accounts for the largest portion of the fifth total score, and outputs information indicating what portion of the bearing has caused the abnormal sound based on the determination result.

Specifically, if the first total score accounts for the largest portion of the fifth total score (step Act29, YES), the pass frequency analysis unit 22 outputs information indicating that the inner ring has caused the abnormal sound (step Act30).

If the first total score does not account for the largest portion of the fifth total score, that is, if another total score accounts for the largest portion (step Act29, NO), the pass frequency analysis unit 22 determines whether the second total score accounts for the largest portion of the fifth total score (step Act31).

If the pass frequency analysis unit 22 determines that the second total score accounts for the largest portion of the fifth total score (step Act31, YES), the pass frequency analysis unit 22 outputs information indicating that the outer ring has caused the abnormal sound (step Act32).

If the second total score also does not account for the largest portion of the fifth total score, that is, if a total score other than the first or second total score accounts for the largest portion (step Act29, NO), the pass frequency analysis unit 22 determines whether the third total score accounts for the largest portion of the fifth total score (step Act33).

If the pass frequency analysis unit 22 determines that the third total score accounts for the largest portion of the fifth total score (step Act33, YES), the pass frequency analysis unit 22 outputs information indicating that the rolling element has caused the abnormal sound (step Act34).

If the pass frequency analysis unit 22 determines that a total score other than the third total score accounts for the largest portion (step Act33, NO), the pass frequency analysis unit 22 determines whether the fourth total score accounts for the largest portion of the fifth total score (step Act35).

If the pass frequency analysis unit 22 determines that the fourth total score accounts for the largest portion of the fifth total score (step Act35, YES), the pass frequency analysis unit 22 outputs information indicating that the retainer of the bearing has caused the abnormal sound (step Act36).

If the pass frequency analysis unit 22 determines that a total score other than the fourth total score accounts for the largest portion (step Act35, NO), the processing is ended.

The output unit 6 provides the user of the abnormal sound determination apparatus 1 or the like with the information output from the pass frequency analysis unit 22. For example, the output unit 6 is a monitor that can provide the user with the information output from the pass frequency analysis unit 22 in a visible manner.

The pass frequency analysis unit 22 may output the information to the communication unit 4. In this case, the communication unit 4 may transmit the information output from the pass frequency analysis unit 22 to a designated communication device, and the designated communication device may be configured to provide the user with the received information.

Next, an example of results of a simulation of abnormal sound determination using the abnormal sound determination apparatus 1 of the embodiment will be described.

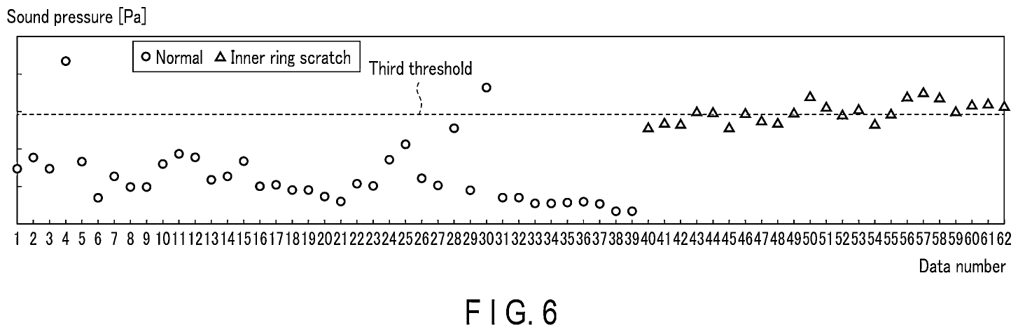

FIG. 6 to FIG. 8 are schematic diagrams showing an example of results of the simulation of the primary determination processing operation of the abnormal sound determination apparatus 1 according to the embodiment.

In the simulation, a plurality of 10-second sound signals are actually measured, and data numbers for identifying results of processing raw waveforms of the sound signals are assigned to the signals. In the simulation, data numbers 1 to 39 correspond to results data of the processing with sound signals when the motor having a normal bearing is operating, and data numbers 40 to 62 correspond to results data of the processing with sound signals when the motor having a bearing in which the inner ring is scratched is operating.

FIG. 6 shows values of the symptom parameters of the data numbers 1 to 62. In this example, the symptom parameters are sound pressures [Pa] (overall value) of the sound signals.

In FIG. 6, for example, the circle “o” represents a sound pressure [Pa] (overall value) of the sound signal acquired when the motor having the normal bearing is operating. The triangle “A” represents a sound pressure [Pa] (overall value) of the sound signal acquired when the motor having the bearing in which the inner ring is scratched is operating.

Referring to the comparison of the symptom parameters with the third threshold shown in FIG. 6, for example, the parameters of data numbers 4 and 30 are equal to or greater than the third threshold, although they are the symptom parameters of operation sounds of the motor having the normal bearing. On the other hand, the parameters of data numbers 40, 41, and 45 are smaller than the third threshold, although they are the symptom parameters of operation sounds of the motor having the bearing in which the inner ring is scratched.

Based on the data, if it is determined what data is based on an operation sound of the motor with an abnormality from only the comparison between the symptom parameter and the third threshold, the primary determination of the abnormality of the motor cannot be performed accurately and the reliability of the abnormality determination may be lowered.

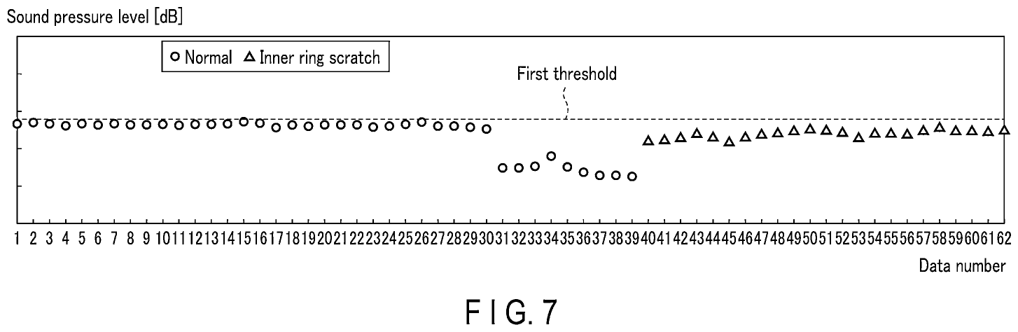

In FIG. 7, for example, the circle “o” represents a sound pressure level [dB] (average value AMP of the amplitudes) of an operation sound of the motor having the normal bearing, and the triangle “A” represents a sound pressure level [dB] (average value AMP of the amplitudes) of an operation sound of the motor having the bearing in which the inner ring is scratched.

Referring to the comparison of the average values AMP of the amplitudes with the first threshold shown in FIG. 7, the values of data numbers 1 and 39 are all smaller than the first threshold, and the values of data numbers 40 to 62 are all equal to or smaller than the first threshold.

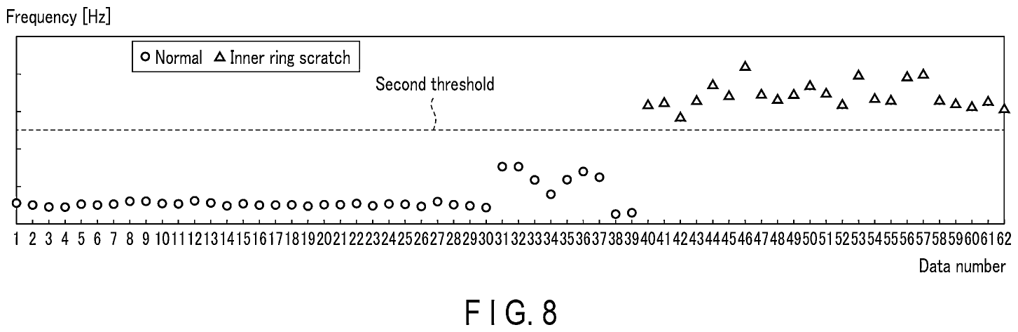

In FIG. 8, for example, the circle “o” represents an average value [Hz] FREQ of the frequency of an operation sound of the motor having the normal bearing, and the triangle “A” represents an average value [Hz] FREQ of the frequency of the motor having the bearing in which the inner ring is scratched.

Referring to the comparison of the average values of the frequencies with the second threshold shown in FIG. 8, the values of data numbers 1 and 39 are all smaller than the second threshold, and the values of data numbers 40 to 62 are all equal to or greater than the second threshold.

From the results of the simulation of the primary determination processing described above, it is understandable that whether the motor has an abnormality can be determined more accurately by performing not only the primary determination of the abnormality of the motor using the symptom parameter (overall value) but also the primary determination of the abnormality of the motor using the average value AMP of the amplitudes and the average value FREQ of the frequencies.

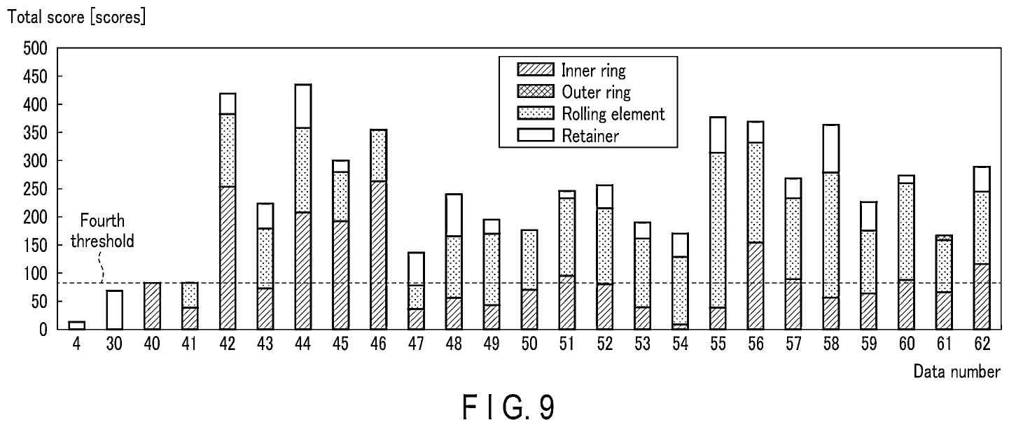

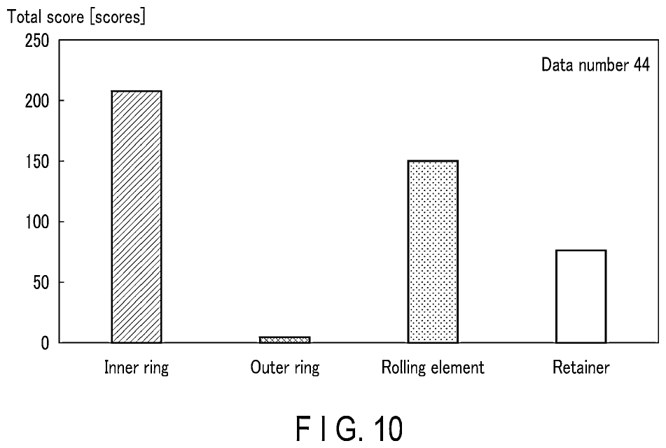

FIG. 9 and FIG. 10 are schematic diagrams showing an example of simulation results of the pass frequency analysis operation of the abnormal sound determination apparatus 1 according to the embodiment.

Descriptions below concern results of the simulation of the pass frequency analysis relating to the sound signals of the data numbers 4, 30, and 40 to 62 in which the symptom parameters are equal to or greater than the third threshold in the primary determination processing.

FIG. 9 is a bar graph showing sums of the first total score (the inner ring), the second total score (the outer ring), the third total score (rolling element), and the fourth total score (retainer) that are calculated for the sound signals of the data numbers 4, 30, and 40 to 62.

In FIG. 9, for example, each of the data numbers 4 and 30 indicates a simulation result of the operation sound of the motor having the normal bearing, and the sum of the total scores is smaller than the fourth threshold. Each of the data numbers 40 to 62 indicates a simulation result of the operation sound of the motor having the bearing in which the inner ring is scratched, and the sum of the total scores is equal to or greater than the fourth threshold.

FIG. 10 shows the first total score to the fourth total score of the simulation results of the data number 44 shown in FIG. 9.

As shown in FIG. 10, for example, referring to the data number 44, the first total score corresponding to the inner ring pass frequency accounted for the largest portion of the fifth total score. Based on this result, the pass frequency analysis unit 22 can specify that the abnormal sound during the operation of the motor was caused by the inner ring.

With the abnormal sound determination apparatus 1 of the embodiment, even if the sound signal includes a noise, the primary determination for determining a motor having an abnormality can be accurately performed by comparing each of the symptom parameter, the average value of amplitudes, and the average value of frequencies in the primary determination processing operation with the predetermined thresholds. Furthermore, with the abnormal sound determination apparatus 1 of the embodiment, ranks (peak ranks) are assigned to the magnitudes of peaks in the amplitude spectrum in the frequency corresponding to causes of the abnormality, and a portion of the bearing that causes the abnormal sound is specified by the sum of scores that are weighted on the basis of peak ranks.

Thus, according to the embodiment, it is possible to provide an abnormal sound determination apparatus that performs abnormal sound determination with high reliability.

The program concerning the present embodiment may be transferred in a state of being stored in an electronic device or in a state of not being stored in an electronic device. In the latter case, the program may be transferred through a network or may be transferred in a state of being stored in a storage medium. The storage medium is a non-transitory tangible medium. The storage medium is a computer-readable medium. The storage medium may be of any type, such as a CD-ROM or a memory card, as long as it can store programs and can be read by the computer.

While several embodiments have been described, these embodiments have been presented by way of example and are not intended to limit the scope of the invention. These novel embodiments may be realized in various other forms, and may be omitted, substituted, or changed within the scope of not departing from the spirit of the invention. The embodiments and their modifications are covered by the accompanying claims and their equivalents, as would fall within the scope and gist of the inventions.

1. An abnormal sound determination apparatus comprising:
a primary determination processing unit configured to calculate a symptom parameter of a frequency component in a predetermined range of a sound signal, and if the symptom parameter is smaller than a third threshold, calculate an average value of amplitudes and an average value of frequencies based on a plurality of peaks in an amplitude spectrum of the sound signal, and perform at least either of comparison between the average value of the amplitudes and a first threshold and comparison between the average value of the frequencies and a second threshold; and
a pass frequency analysis unit configured to, if a result of the comparison in the primary determination processing unit satisfies a predetermined condition, acquire values and frequencies of a plurality of peaks included in an amplitude spectrum based on a portion of the sound signal, calculate ranks of the values of the plurality of peaks a plurality of times for different portions of the sound signal, and determine a cause of an abnormal sound based on a total score obtained by summing scores set in accordance with the ranks for each of the frequencies of the plurality of peaks.

2. The abnormal sound determination apparatus according to claim 1, wherein:
the pass frequency analysis unit sets a predetermined time width, acquires scores based on the ranks of the values of the plurality of peaks for each of the frequencies of the plurality of peaks using the amplitude spectrum based on a portion of the sound signal corresponding to the time width, and calculates a total score for each of the frequencies of the plurality of peaks of the scores acquired for a plurality of portions of the sound signal corresponding to the time width; and
the plurality of portions of the sound signal corresponding to the time width overlap another portion.

3. The abnormal sound determination apparatus according to claim 1, wherein the pass frequency analysis unit compares a sum of total scores for the frequencies of the plurality of peaks with a fourth threshold, and if the sum is smaller than the fourth threshold, ends processing.

4. The abnormal sound determination apparatus according to claim 1, wherein the pass frequency analysis unit compares a sum of total scores for the frequencies of the plurality of peaks with a fourth threshold, and if the sum is equal to or greater than the fourth threshold, determines the cause of the abnormal sound based on a frequency corresponding to a total score that accounts for a largest portion of the sum.
